(19) United States
(12) Patent Application Publication
(10) Pub. No.: US 2025/0168742 A1
(43) Pub. Date: May 22, 2025

(54) SYSTEMS AND METHODS FOR SELF-IDENTIFYING ACTIVE RELAY

(71) Applicants: Subhan Zakir, Tempe, AZ (US); Saeed Zeinolabedinzadeh, Chandler, AZ (US); Waleed Ahmad, Tempe, AZ (US)

(72) Inventors: Subhan Zakir, Tempe, AZ (US); Saeed Zeinolabedinzadeh, Chandler, AZ (US); Waleed Ahmad, Tempe, AZ (US)

(73) Assignee: Arizona Board of Regents on Behalf of Arizona State Unversity, Tempe, AZ (US)

(21) Appl. No.: 18/956,906

(22) Filed: Nov. 22, 2024

Related U.S. Application Data
(60) Provisional application No. 63/601,924, filed on Nov. 22, 2023.

(51) Int. Cl. H04W 40/22

(52) U.S. Cl. CPC H04W 40/22

(57) ABSTRACT

A wireless communication network includes a plurality of relay devices and a base station device, where each relay device adds a relay identification code into a modulated signal for interpretation by the base station device. The base station device can determine which relay devices can communicate with a user device without obstruction. Further, the base station can also determine the location of the user device, which is significant for localization in outdoor environments, and even more so in indoor environments where GPS signals may not be available.

### CROSS REFERENCE TO RELATED APPLICATIONS

This is a non-provisional application that claims benefit to U.S. Provisional Application Ser. No. 63/601,924, filed on Nov. 22, 2023, which is herein incorporated by reference in its entirety.

### GOVERNMENT SUPPORT

This invention was made with government support under N00014-21-1-2897 awarded by the Office of Naval Research. The government has certain rights in the invention.

### FIELD

The present disclosure generally relates to active relays in wireless networks, and in particular, to a wireless network having self-identifying relay devices that enable localization of a user device.

### BACKGROUND

Localization and link establishment between a base station device and a user device are one of the major challenges for 5G and future wireless communication systems. These challenges require very high bandwidth or information like time of flight, angle of arrival, angle of departure and multi-path resolution which require large antenna arrays. Along all these, they require complicated algorithms and signal processing techniques which is both time- and power-consuming.

It is with these observations in mind, among others, that various aspects of the present disclosure were conceived and developed.

### BRIEF DESCRIPTION OF THE DRAWINGS

FIG. 1 is a simplified diagram illustrating a wireless network including a user device that sends a signal to a plurality of relay devices, which each modify the signal with a unique code prior to forwarding the signal onward to a base station;

FIG. 2 is a simplified diagram illustrating the wireless network of FIG. 1 with time differences used by the base station to determine a location of the user device based on the signals received from the plurality of relay devices;

FIG. 3 is a simplified diagram illustrating operation of a relay device of the plurality of relay devices of FIG. 1;

FIG. 4 is a simplified diagram showing an example computing system that can be a component of a base station of FIG. 1 for implementation of the methods outlined herein; and

FIGS. 5A-5D are a series of process flow diagrams showing a method that can be implemented by the wireless network of FIG. 1.

Corresponding reference characters indicate corresponding elements among the view of the drawings. The headings used in the figures do not limit the scope of the claims.

### DETAILED DESCRIPTION

In 5G wireless communication networks, active relays have become a favorable solution for blockage mitigation and broader coverage. However, for successful navigation of a signal through relays of a wireless communication network, it is crucial to know a physical position of a user device as well as respective physical positions of relay devices which can guide the signal to the user device with as little obstruction as possible. To achieve this goal, a relay architecture for a relay device of a wireless communication network is outlined herein which can augment a transmitted signal to include a unique relay identification code. Using these codes, a base station, access point, or a user of the wireless communication network can identify which relay device transmitted the signal. By measuring time delays from multiple relay devices, a physical location of the user device can also be determined. In a further aspect, the code added by the relay device also acts as an additional physical security layer.

5G Wireless systems have the potential to crater the growing demand of high data rates. However, these 5G systems have certain challenges such as signal obstruction, poor penetration, high propagation loss and poor scattering which needs to be resolved for widespread use of 5G. One of the remedies for these challenges is to use active relays to improve the 5G communication links. Active relay devices can re-route a signal to avoid obstructions and thus can provide uninterrupted 5G service. However, dense environments can still cause obstruction in signals coming from active relay devices, especially when the user device is moving. Henceforth, it is important to know which relay devices can route the signal from base station to the user without blockage, and vice versa. Due to poor penetration and scattering of millimeter wave (mmW) signals, it is also very crucial to know the position of the user device to select the best relay devices that can transfer the data between a base station and the user device without excessive signal degradation or connectivity loss. Different types of relay architectures have been proposed in the literature. However, in these relay architectures, a base station cannot determine if a signal path is blocked, nor can these relay devices provide any information regarding the position of the user device.

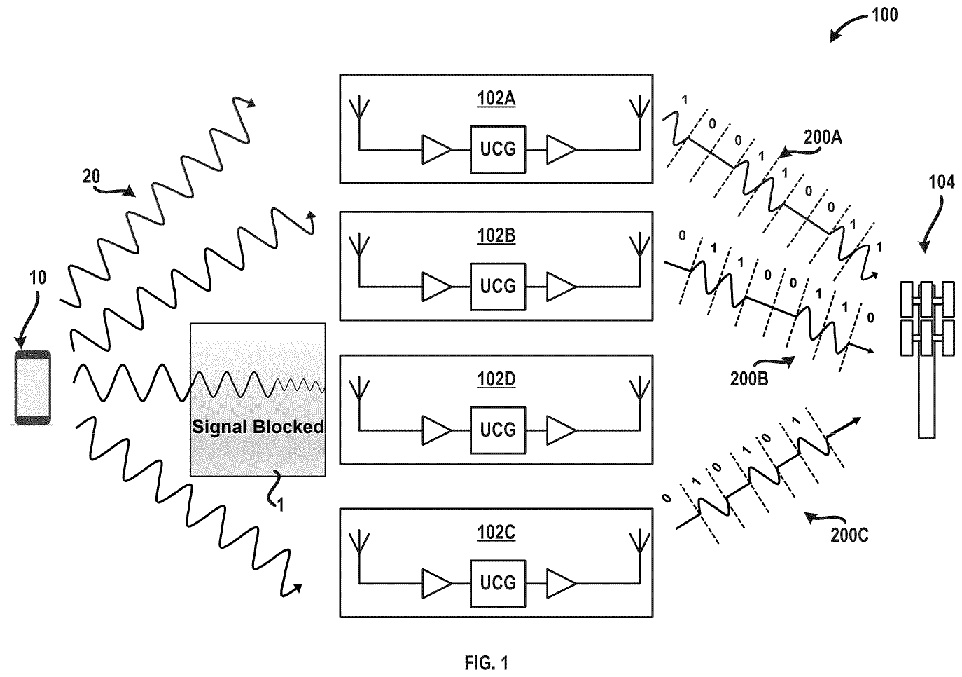

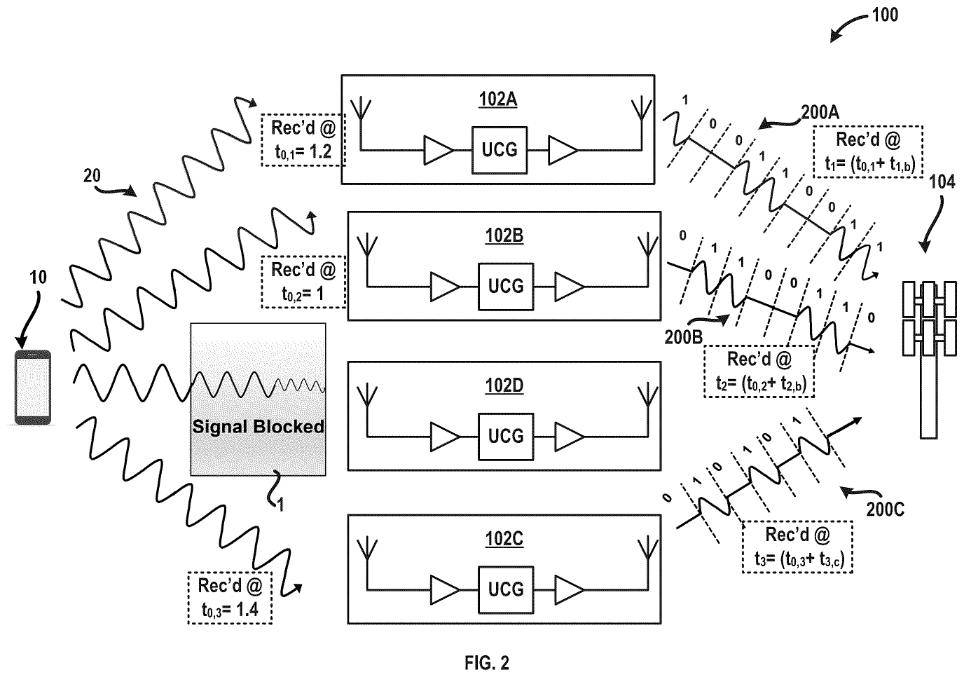

FIGS. 1-3 show an example of a wireless communication network 100 including a user device 10, a plurality of relay devices (shown in FIGS. 1 and 2 as relay devices 102A-102D), and a base station device 104. The base station device 104 can determine which relay devices of the plurality of relay devices can communicate with a user device 10 with the least obstruction. Further, the base station device 104 can also provide information regarding the location of the user which is significant for localization in outdoor environments and even more so in indoor environments where GPS signals may not be available.

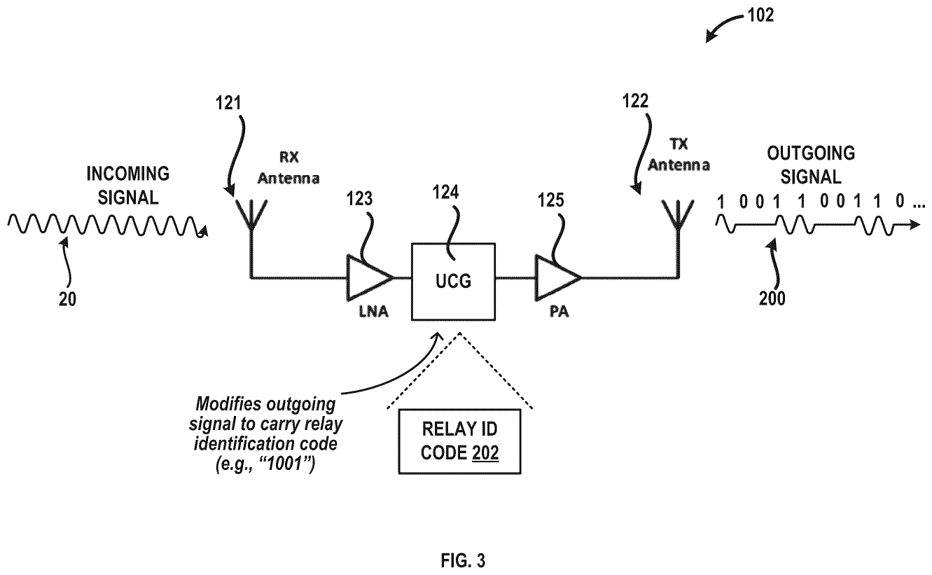

In particular, a relay device 102 of the plurality of relay devices outlined herein is self-identifying. FIG. 3 shows operation of the relay device 102. Upon receipt of an incoming signal 20 (such as a packet) to be forwarded, the relay device 102 augments the signal to include a relay identification code 202 before transmitting the signal as a modulated signal 200 onward to another device (e.g., the base station device 104, or alternatively, the user device 10 or another relay device 102). The relay identification code 202 is unique to the relay device 102. Based on the relay identification code 202, the base station device 104 and the user device 10 can identify the relay device 102 which transmitted the signal. The base station device 104 can also localize and track the user device 10 by measuring the delay in the received signals from different relay devices (e.g., modulated signals 200A, 200B and 200C from respective relay devices 102A, 102B and 102D shown in FIG. 2). Based on the relay identification codes within the signals received at the base station device 104 and/or the user device 10, the base station device 104 or user device 10 can identify which relay devices 102 can transmit data with the least obstruction or blockage. The relay identification codes also provide an additional physical layer of security on data carried by the signals.

The relay devices proposed in previous literature do not have the capability to differentiate between one another that would allow a base station to determine which relay sent a signal based on the signal itself. In contrast, the relay devices 102 outlined herein add relay identification codes 202 to modulated signals 200 and thus aids in localization of the user device 10, provides information regarding signal obstruction, and also adds an additional physical layer of security all in the front end. Further, the relay devices 102 outlined herein aim to limit processing delays and power consumption in signal processing.

In a relay-based communication network such as wireless communication network 100, the user device 10 and the base station device 104 can communicate with one another, with active relay devices (e.g., relay device 102) being operable for intermediately forwarding communications between the user device 10 and the base station device 104. The user device 10 sends a signal and an active relay device (e.g., relay device 102) receives the signal and forwards the signal towards the base station device 104, and vice versa. For 5G wireless communications, localization is very crucial for several factors such as but not limited to: beamforming, resource management, network efficiency, privacy and security, etc. In previous literature, researchers have proposed various techniques and algorithms to estimate the position of the user. For example, many techniques use multi-paths to localize the user, but require measurements like Angle of Arrival (AoA), Angle of Departure (AoD) (both require large antenna arrays) and Time of Flight (TOF). These measurements are complicated and require a lot of bandwidth and computation and thus are not suitable for practical cases with large number of users.

In contrast, the present disclosure outlines a simpler and more practical scheme which avoids the use of large antenna arrays or consumption of high bandwidth. In particular, each relay device 102 of the wireless communication network 100 modulates (or otherwise augments) and forwards the signal with relay identification codes that are unique to individual relay devices. If the base station device 104 knows the position of each relay device 102, then by identifying the relay identification codes from each relay device 102, the base station device 104 can approximate the location of the user device 10. Using the relay identification codes, the base station device 104 can identify from which relay device 102 the data was received from, and thus by measuring time delays between the data received through multiple relay devices 102 (which each add their own relay identification codes to the data), the base station device 104 can localize the user device 10. Using these relay identification codes, the base station device 104 can also determine which relay devices 102 can communicate with the user with little to no obstruction.

The relay identification codes also add a security layer over data, since data within a signal received from a relay device 102 can only be demodulated by applying the correct relay identification code. There can be various ways that a relay device 102 can add these relay identification codes on to the data. For example, a relay device 102 can transmit the data using unique carrier or subcarrier frequencies that correspond with the relay identification code to differentiate from other relay devices, or can add the relay identification code into a carrier phase or amplitude of a modulated signal. The incorporation of the relay identification code into a modulated signal is not limited to the above-mentioned techniques. In some examples, the user device 10 is aware of the relay identification codes.

In the example of FIG. 1, three or more relay devices (e.g., first, second and third relay devices 102A, 102B and 102C) each receive an incoming signal 20 from the user device 10, where the incoming signal 20 can carry data to be relayed to the base station device 104. The data may be as simple as a “ping” message for localization of the user device 10, or could be one of a plurality of packets carrying data to be sent or a request for data. As shown in the example, a fourth relay device 102D does not receive the incoming signal 20 due to an obstacle 1.

The first relay device 102A, the second relay device 102B, and the third relay device 102C each have an associated relay identification code (e.g., “1001” for first relay device 102A, “0110” for second relay device 102B and “0101” for third relay device 102C) and augment the incoming signal 20 to include the relay identification code. As shown, the first relay device 102A constructs and transmits a first modulated signal 200A to the base station device 104 that carries a (first) relay identification code associated with the first relay device 102A. Likewise, the second relay device 102B constructs and transmits a second modulated signal 200B to the base station device 104 that carries a (second) relay identification code associated with the second relay device 102B. In a similar fashion, the third relay device 102C constructs and transmits a third modulated signal 200C to the base station device 104 that carries a (third) relay identification code associated with the third relay device 102C. Because the fourth relay device 102D did not receive the incoming signal 20 from the user device 10 due to obstruction, the fourth relay device 102D does not transmit a modulated signal to the base station device 104.

The locations of the first relay device 102A, the second relay device 102B, and the third relay device 102C can be known to the base station device 104. Further, the relay identification codes are also known to the base station device 104. Upon receipt of the first modulated signal 200A, the second modulated signal 200B, and the third modulated signal 200C (and with the knowledge that there was no modulated signal associated with the fourth relay device 102D) the base station device 104 can infer the location of the user device 10 by measuring a time difference of arrival of these modulated signals. Such an operation is illustrated in FIG. 2.

FIG. 2 shows the wireless communication network 100 as in FIG. 1 further showing how the base station device 104 can infer the location of the user device 10. As discussed, consider that the base station device 104 does not know the location of the user device 10, but does know the locations of the first, second, third, and fourth relay devices 102A-102D. Consider that the incoming signal 20 is sent from the user device 10, and is received at the first relay device 102A at time t_{0,1}, at the second relay device 102B at time t_{0,2} and at the third relay device 102C at time t_{0,3}. As discussed, the fourth relay device 102D may never receive the incoming signal 20 due to a blockage (even if it is closer to the user device 10). For this example, consider that t_{0,1}=1.2, t_{0,2}=1 and t_{0,3}=1.4 (e.g., where the user device 10 is physically closest to the second relay device 102B).

In the example of FIG. 2, the first relay device 102A modifies the first modulated signal 200A to include its relay identification code (e.g., “1001”), the second relay device 102B modifies the second modulated signal 200B to include its relay identification code (e.g., “0110”) and the third relay device 102C modifies the third modulated signal 200C to include its relay identification code (e.g., “0101”). The modulated signals 200A, 200B and 200C are sent to the base station device 104. In the example, the base station device 104 receives the first modulated signal 200A at time t₁=(t_{0,1}+t_{1,b}), receives the second modulated signal 200B at time t₂=(t_{0,2}+t_{2,b}) and receives the third modulated signal 200C at time t₃=(t_{0,3}+t_{3,b}). The base station device 104 may already know expected travel times between each respective relay device 102 (e.g., as t_{1,b}, t_{2,b} and t_{3,b}) due to the base station device 104 knowing the locations of the relay devices 102 which may have fixed “relay distances” from the base station device 104. As the user device 10 moves, “user distances” between the user device 10 and respective relay devices 102 will vary which can be reflected in differences in arrival times. The base station device 104 can measure the time difference of arrival of modulated signals 200A, 200B and 200C e.g., TD_{2,1}=(t₂−t₁), TD_{3,2}=(t₃−t₂), TD_{3,1}=(t₃31 t₁). Because the base station device 104 knows the locations of the first relay device 102A, the second relay device 102B and the third relay device 102C, the base station device 104 can deduce an approximate location of the user device 10. Further, because the base station device 104 knows the respective relay identification codes of the first relay device 102A, the second relay device 102B and the third relay device 102C, the base station device 104 can: a) demodulate the first modulated signal 200A, the second modulated signal 200B and the third modulated signal 200C; and b) determine which relay device sent which modulated signal. The base station device 104 may route further communications towards the user device 10 through the appropriate relay device, which may be the closer relay device (e.g., in the example, this may be the second relay device 102B, with the first relay device 102A and the third relay device 102C being a second choice and third choice respectively) or the base station device 104 may route further communications towards the user device 10 through distributed beamforming using first, second, and third relay devices 102A, 102B and 102C. The process may be repeated at a later time step in case the user device 10 moves or an obstruction appears or disappears.

FIG. 3 is a simplified diagram showing operation of a relay device 102 as outlined above. The relay device 102 can include a receiver (RX) antenna 121 that receives the incoming signal 20. In some examples, the relay device 102 can include a low-noise amplifier (LNA) 123 that amplifies the incoming signal 20 for processing by the relay device 102. The relay device 102 can also include unique code generator (UCG) components (e.g., modulator element 124) that modify the incoming signal 20 to include the relay identification (ID) code 202 that is uniquely associated with the relay device 102. In some examples, the modulator element 124 can include RF switches or microwave switches as code generation components, although different circuit architectures can be utilized to add the relay identification code into a signal. The modified signal may then be subjected to a power amplifier (PA) 125 before being transmitted as the modulated signal 200 to a further recipient (e.g., the base station device 104 of FIGS. 1 and 2) through a transmitter (TX) antenna 122.

As discussed, there can be multiple possible ways that a relay device 102 can add these relay identification codes, including but not limited to unique carrier frequencies, amplitudes or phases.

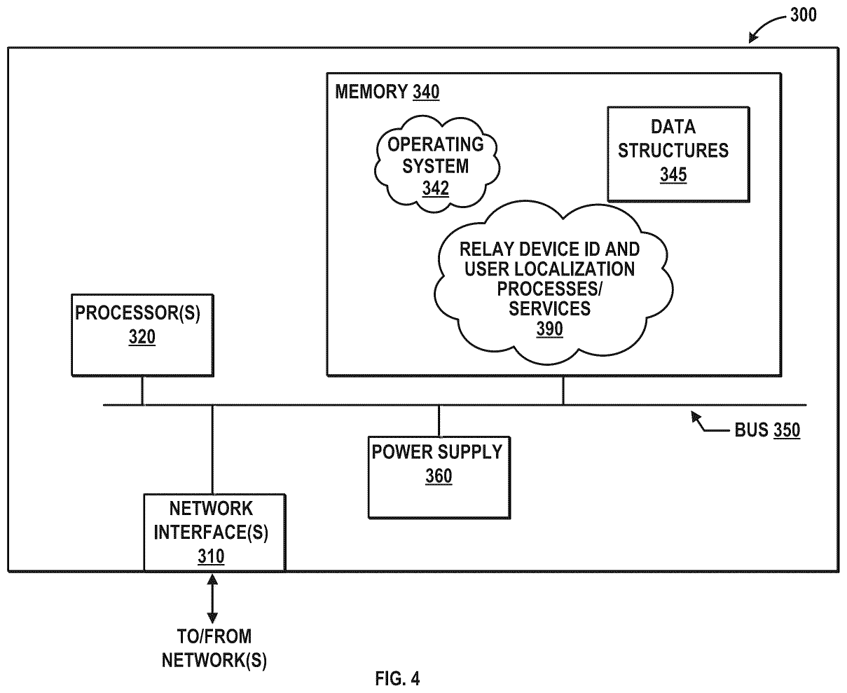

FIG. 4 is a schematic block diagram of an example device 300 that may be used with one or more embodiments described herein, e.g., as base station device 104 shown in FIGS. 1 and 2.

Device 300 comprises one or more network interfaces 310 (e.g., wired, wireless, PLC, etc.), at least one processor 320, and a memory 340 interconnected by a system bus 350, as well as a power supply 360 (e.g., battery, plug-in, etc.).

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360.

Memory 340 includes a plurality of storage locations that are addressable by processor 320 and network interfaces 310 for storing software programs and data structures associated with the embodiments described herein. In some embodiments, device 300 may have limited memory or no memory (e.g., no memory for storage other than for programs/processes operating on the device and associated caches). Memory 340 can include instructions executable by the processor 320 that, when executed by the processor 320, cause the processor 320 to implement aspects of the wireless communication network including base station device 104 and associated methods outlined herein.

Processor 320 comprises hardware elements or logic adapted to execute the software programs (e.g., instructions) and manipulate data structures 345. An operating system 342, portions of which are typically resident in memory 340 and executed by the processor, functionally organizes device 300 by, inter alia, invoking operations in support of software processes and/or services executing on the device. These software processes and/or services may include Relay Device ID and User Localization processes/services 390, which can include aspects of the methods and/or implementations of various modules described herein.

Note that while Relay Device ID and User Localization processes/services 390 is illustrated in centralized memory 340, alternative embodiments provide for the process to be operated within the network interfaces 310, such as a component of a MAC layer, and/or as part of a distributed computing network environment.

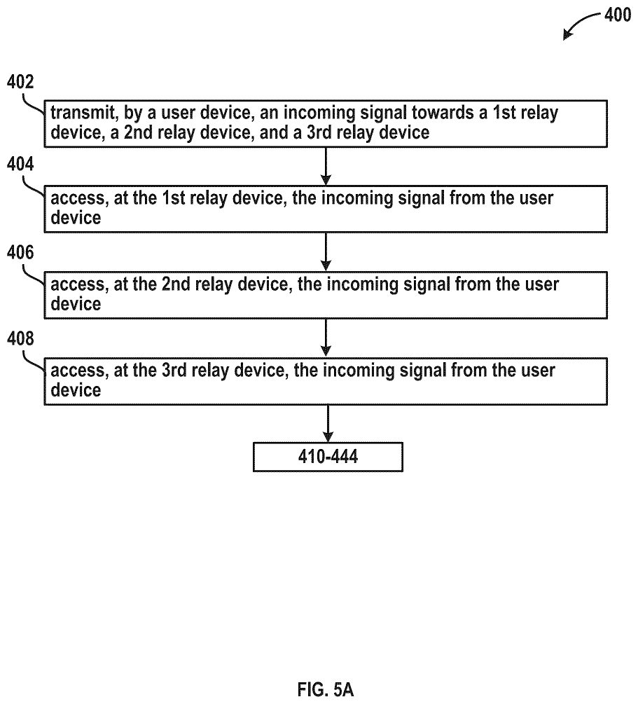

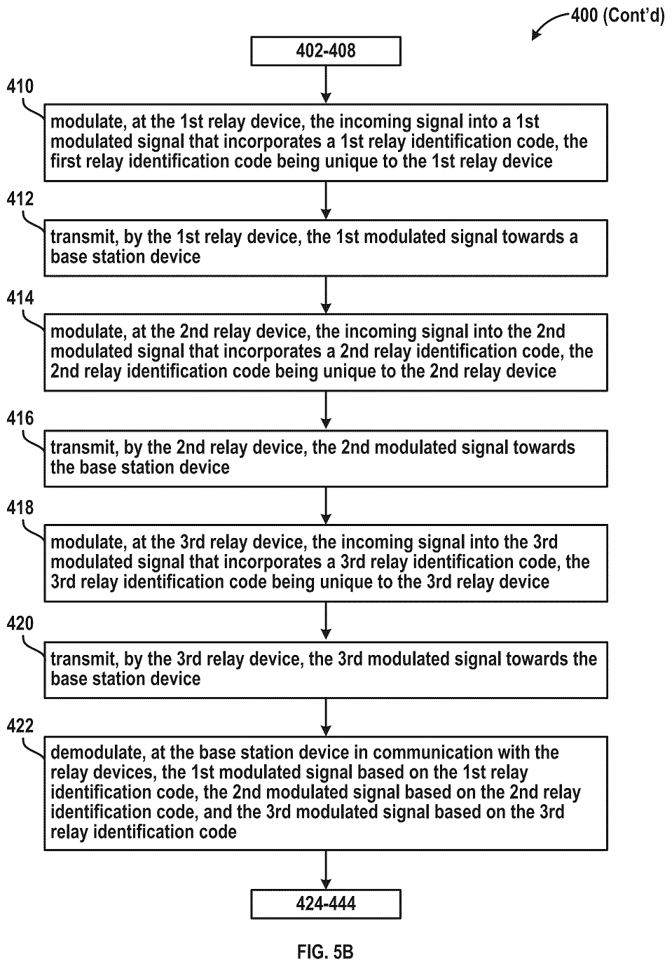

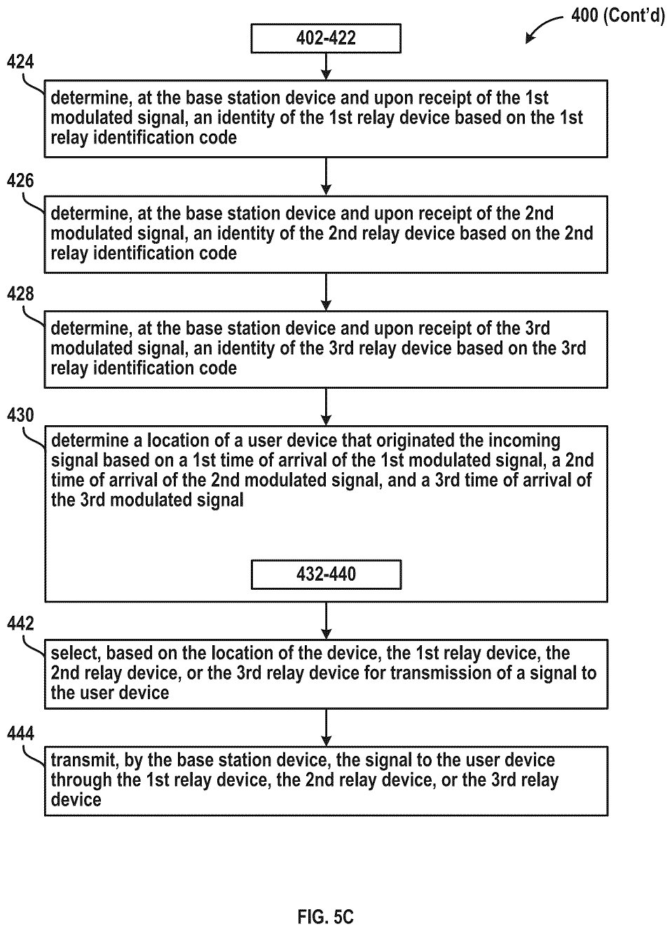

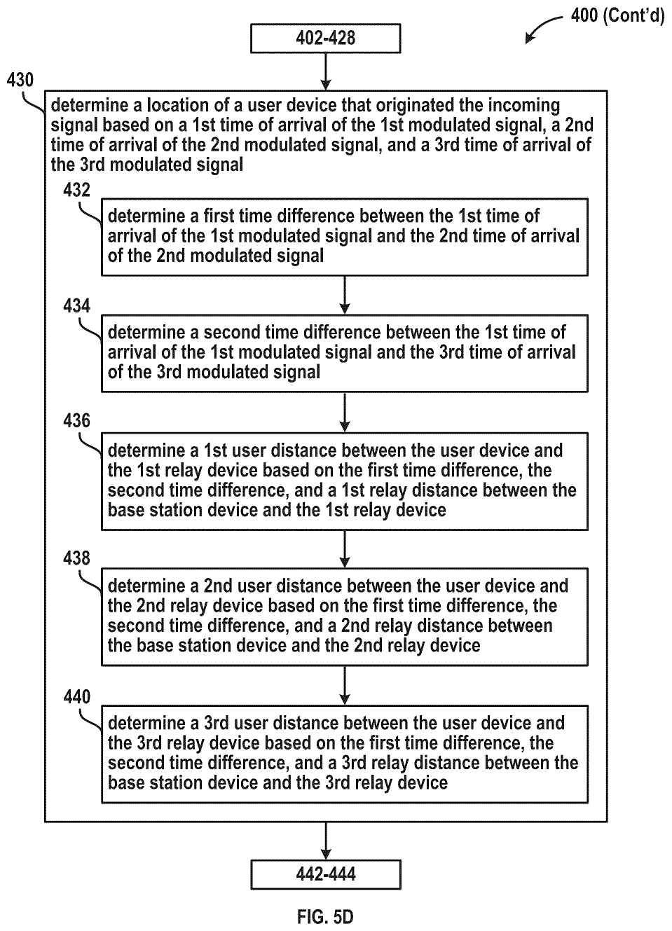

FIGS. 5A-5D show a method 400 which can be implemented using the wireless communication network 100 of FIGS. 1 and 2.

Referring to FIG. 5A, step 402 of method 400 includes transmitting, by a user device, an incoming signal towards a first relay device and a second relay device. Step 404 of method 400 includes accessing, at the first relay device, the incoming signal from the user device (e.g., after capturing the incoming signal from the user device at a receiver element of the first relay device). Likewise, step 406 of method 400 includes accessing, at the second relay device, the incoming signal from the user device (e.g., after capturing the incoming signal from the user device at a receiver element of the second relay device); and step 408 of method 400 includes accessing, at the third relay device, the incoming signal from the user device (e.g., after capturing the incoming signal from the user device at a receiver element of the third relay device).

Continuing with FIG. 5B, step 410 of method 400 includes modulating (or otherwise constructing), at the first relay device, the incoming signal into a first modulated signal that incorporates a first relay identification code (e.g., by a modulator element configured to modulate the incoming signal into the first modulated signal that incorporates the first relay identification code), the first relay identification code being unique to the first relay device. The modulator element can be configured to incorporate the first relay identification code into the first modulated signal as a unique carrier frequency, a unique carrier phase, and/or as a unique carrier amplitude. Step 412 of method 400 includes transmitting, by the first relay device (e.g., by a transmitter element of the first relay device), the first modulated signal towards a base station device.

Step 414 of method 400 can include modulating (or otherwise constructing), at the second relay device, the incoming signal into the second modulated signal that incorporates a second relay identification code (e.g., by a modulator element configured to modulate the incoming signal into the second modulated signal that incorporates the second relay identification code), the second relay identification code being unique to the second relay device. Likewise, the modulator element can be configured to incorporate the second relay identification code into the second modulated signal as a unique carrier frequency, a unique carrier phase, and/or as a unique carrier amplitude. Step 416 of method 400 includes transmitting, by the second relay device, the second modulated signal towards the base station device.

Step 418 of method 400 can include modulating (or otherwise constructing), at the third relay device, the incoming signal into the second modulated signal that incorporates a third relay identification code (e.g., by a modulator element configured to modulate the incoming signal into the third modulated signal that incorporates the third relay identification code), the third relay identification code being unique to the third relay device. Likewise, the modulator element can be configured to incorporate the second relay identification code into the second modulated signal as a unique carrier frequency, a unique carrier phase, and/or as a unique carrier amplitude. Step 420 of method 400 includes transmitting, by the third relay device, the third modulated signal towards the base station device.

Step 422 of method 400 includes demodulating, at the base station device in communication with the plurality of relay devices (e.g., the first relay device, the second relay device, and the third relay device), the first modulated signal based on the first relay identification code, the second modulated signal based on the second relay identification code, and the third modulated signal based on the third relay identification code to obtain the incoming signal as originally sent by the user device. The base station device can access the first modulated signal received from the first relay device of the plurality of relay devices, the second modulated signal received from the second relay device of the plurality of relay devices, and the third modulated signal received from the third relay device of the plurality of relay devices. Importantly, the first modulated signal, the second modulated signal, and the third modulated signal are commonly associated with the incoming signal that originated from the user device.

Referring to FIG. 5C, step 424 of method 400 includes determining, at the base station device and upon receipt of the first modulated signal, an identity of the first relay device based on the first relay identification code present within the first modulated signal. Likewise, step 426 of method 400 includes determining, at the base station device and upon receipt of the second modulated signal, an identity of the second relay device based on the second relay identification code present within the second modulated signal; and, step 428 of method 400 includes determining, at the base station device and upon receipt of the third modulated signal, an identity of the third relay device based on the third relay identification code present within the third modulated signal.

With brief reference to FIG. 5D, step 430 of method 400 can include determining, a location of a user device that originated the incoming signal based on a first time of arrival of the first modulated signal at the base station device, a second time of arrival of the second modulated signal at the base station device, and a third time of arrival of the third modulated signal at the base station device. Step 430 can encompass steps 432-4440. Step 432 of method 400 can include determining a first time difference between the first time of arrival of the first modulated signal at the base station device and the second time of arrival of the second modulated signal at the base station device. Step 434 of method 400 can include determining a second time difference between the first time of arrival of the first modulated signal at the base station device and the third time of arrival of the third modulated signal at the base station device. Step 436 of method 400 can include determining a first user distance between the user device and the first relay device based on the first time difference, the second time difference, and a first relay distance between the base station device and the first relay device. Likewise, step 438 of method 400 can include determining a second user distance between the user device and the second relay device based on the first time difference, the second time difference, and a second relay distance between the base station device and the second relay device; step 440 of method 400 can include determining a third user distance between the user device and the third relay device based on the first time difference, the second time difference, and a third relay distance between the base station device and the third relay device.

Returning to FIG. 5C, step 442 of method 400 can include selecting, based on the location of the device, the first relay device, the second relay device, or the third relay device for transmission of a signal to the user device that originated the incoming signal. Step 444 of method 400 can include transmitting, by the base station device, the signal to the user device through the first relay device, the second relay device, or the third relay device.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the Relay Device ID and User Localization processes/services 390 is shown as a standalone process, those skilled in the art will appreciate that this process may be executed as a routine or module within other processes.

What is claimed is:

1. A wireless network, including:
a base station device in communication with a plurality of relay devices, the base station device being configured to:
access three or more modulated signals, each modulated signal of the three or more modulated signals respectively originating from a relay device of the plurality of relay devices and being commonly associated with an incoming signal originating from a user device;
determine, for a modulated signal of the three or more modulated signals, an identity of the relay device of the plurality of relay devices associated with the modulated signal based on a relay identification code within the modulated signal, the relay identification code being uniquely associated with the relay device of the plurality of relay devices; and
determine a location of the user device based on: a first time difference between receipt of a first modulated signal and a second modulated signal of the three or more modulated signals; and a second time difference between receipt of the first modulated signal and a third modulated signal of the three or more modulated signals.

2. The wireless network of claim 1, each relay device of the plurality of relay devices being configured to:
access the incoming signal originated from the user device;
construct a modulated signal that includes the incoming signal modified with a relay identification code, the relay identification code being unique to the relay device; and
transmit the modulated signal to the base station device.

3. The wireless network of claim 2, the base station device being configured to:
demodulate the modulated signal using the relay identification code to obtain the incoming signal as originally sent by the user device.

4. The wireless network of claim 1, the base station device being configured to:
determine, for a relay device of the plurality of relay devices, a user distance between the user device and the relay device associated with a modulated signal based on the first time difference, the second time difference, and a relay distance between the base station device and the relay device.

5. The wireless network of claim 1, the base station device being configured to:
select a relay device of the plurality of relay devices for transmission of a signal to the user device based on the location of the user device.

6. A wireless network, including:
a plurality of relay devices in communication with a base station device, each relay device of the plurality of relay devices being configured to:
access an incoming signal originated from a user device;
construct a modulated signal that includes the incoming signal modified with a relay identification code, the relay identification code being unique to the relay device; and
transmit the modulated signal to the base station device.

7. The wireless network of claim 6, the base station device being configured to:
access the modulated signal received from the relay device; and
associate the modulated signal with the relay device based on the relay identification code.

8. The wireless network of claim 6, the base station device being configured to:
access three or more modulated signals, each modulated signal of the three or more modulated signals respectively originating from a relay device of the plurality of relay devices and being commonly associated with the incoming signal originating from the user device;
determine, for a modulated signal of the three or more modulated signals, an identity of the relay device associated with the modulated signal based on the relay identification code within the modulated signal, the relay identification code being uniquely associated with the relay device of the plurality of relay devices; and
determine a location of the user device based on: a first time difference between receipt of a first modulated signal and a second modulated signal of the three or more modulated signals; and a second time difference between receipt of the first modulated signal and a third modulated signal of the three or more modulated signals.

9. A method, comprising:
modulating, at a first relay device of a plurality of relay devices, an incoming signal into a first modulated signal that incorporates a first relay identification code, the first relay identification code being unique to the first relay device;
modulating, at a second relay device of the plurality of relay devices, the incoming signal into a second modulated signal that incorporates a second relay identification code, the second relay identification code being unique to the second relay device;
modulating, at a third relay device of the plurality of relay devices, the incoming signal into a third modulated signal that incorporates a third relay identification code, the third relay identification code being unique to the third relay device; and
demodulating, at a base station device in communication with the plurality of relay devices, the first modulated signal based on the first relay identification code, the second modulated signal based on the second relay identification code, and the third modulated signal based on the third relay identification code.

10. The method of claim 9, further comprising:
determining a location of a user device that originated the incoming signal based on a first time of arrival of the first modulated signal at the base station device, a second time of arrival of the second modulated signal at the base station device, and a third time of arrival of the third modulated signal at the base station device.

11. The method of claim 10, further comprising:
determining a first time difference between receipt of the first modulated signal and the second modulated signal, and a second time difference between receipt of the first modulated signal and the third modulated signal; and
determining, for a relay device of the plurality of relay devices, a user distance between the user device and the relay device associated with a modulated signal based on the first time difference, the second time difference, and a relay distance between the base station device and the relay device.

12. The method of claim 9, further comprising:
selecting a relay device of the plurality of relay devices for transmission of a signal to a user device that originated the incoming signal based on a first time of arrival of the first modulated signal at the base station device, a second time of arrival of the second modulated signal at the base station device, and a third time of arrival of the third modulated signal at the base station device.

13. The method of claim 9, further comprising:
determine, for a modulated signal, an identity of a relay device of the plurality of relay devices associated with the modulated signal based on a relay identification code within the modulated signal, the relay identification code being uniquely associated with the relay device of the plurality of relay devices.

14. The method of claim 9, further comprising:
accessing, at the first relay device, the incoming signal from a user device;
accessing, at the second relay device, the incoming signal from the user device; and
accessing, at the third relay device, the incoming signal from the user device.

15. The method of claim 9, further comprising:
transmitting, by a user device, the incoming signal towards the first relay device, the second relay device, and the third relay device.

16. A relay device, comprising:
a receiver element configured to capture an incoming signal from a user device;
a modulator element configured to modulate the incoming signal into a modulated signal that incorporates a relay identification code, the relay identification code being unique to the modulator element; and
a transmitter element configured to transmit the modulated signal to a base station device.

17. The relay device of claim 16, the modulator element being configured to incorporate the relay identification code into the modulated signal as a unique carrier frequency.

18. The relay device of claim 16, the modulator element being configured to incorporate the relay identification code into the modulated signal as a unique carrier phase.

19. The relay device of claim 16, the modulator element being configured to incorporate the relay identification code into the modulated signal as a unique carrier amplitude.
